(19) United States
(12) Patent Application Publication
(10) Pub. No.: US 2017/0251866 A1
(43) Pub. Date: Sep. 7, 2017

(54) MULTIPLE-POD BREWING APPARATUS AND SYSTEM

(71) Applicant: CE brands, LLC, Miami, FL (US)

(72) Inventor: Jorge Garcia, Rogers, AR (US)

(73) Assignee: CE Brands, LLC, Miami, FL (US)

(21) Appl. No.: 15/450,905

(22) Filed: Mar. 6, 2017

Related U.S. Application Data
(60) Provisional application No. 62/303,703, filed on Mar. 4, 2016.

(51) Int. Cl. A47J 31/44; A47J 31/40

(52) U.S. Cl. CPC A47J 31/4403; A47J 31/407

(57) ABSTRACT

The invention discussed herein discloses an apparatus for use in a brewing appliance. The apparatus is configured to receive two or more standard beverage pods and a multi-point water dispensing manifold delivers the water to the pods for steeping of the liquid. By way of example, the apparatus disclosed as the present invention may be used to brew two or more standard beverage pods, simultaneously, as may be desired by the user.

### CROSS-REFERENCE TO RELATED APPLICATIONS

This non-provisional utility patent application claims the benefit of U.S. Provisional Patent Application No. 62/303,703, filed on Mar. 4, 2016, currently pending, which is incorporated herein by reference.

### STATEMENT REGARDING FEDERALLY SPONSORED-RESEARCH OR DEVELOPMENT

None.

### FIELD OF THE INVENTION

The invention relates generally to the field of electro-mechanical apparatuses, and more particularly, to an apparatus that is configured to brew multiple coffee pods simultaneously.

### BACKGROUND

Pod-based coffee makers have become extremely popular based upon their ease, price, and convenience. In these types of brewing systems, coffee, tea, or other dry, water-soluble, beverage substance is pre-measured and packaged in a container that acts as a storage medium as well as the filter means. These are known in the art as “pods”. Some pods come pre-measured and pre-packaged by a manufacturer for single-use. Other pods are re-usable and fillable by a user.

While it is known in the art that these pods are convenient in terms of ease-of-use, easy cleanup, and consistent beverage quality, the currently available pods suffer from a major setback—all currently available pods are limited in the amount of coffee they can make. Pod-based coffee makers as are known in the art are single-serve machines, with the volume of beverage dispensed controlled by the size of popularly available pods—typically 6-8 oz. Larger servings can only be accomplished by adding more water—producing a more diluted beverage.

Current trends indicate that consumers want to consume larger cups of coffee but do not want to go through the delay of brewing multiple single pods in series. Some attempts to address this problem in the art have presented larger pods that can hold more dry material and yield larger amounts of the beverage. The problem with this is that it requires a specialized pod brewer and the selection and variety of beverages available in the larger size is only a fraction of those available in the standard size.

There exists a need, therefore, for a brewing apparatus that is configured to accept more than one standard pod. It would be further desirable for the brewing apparatus to be able to detect the number of pods present and dispense only the amount of water necessary to properly brew the amount of beverage present, as desired by the use.

While certain aspects of conventional technologies have been discussed to facilitate disclosure of the invention, Applicant in no way disclaims these technical aspects, and it is contemplated that the claimed invention may encompass one or more of the conventional technical aspects discussed herein.

In this specification where a document, act, or item of knowledge is referred to or discussed, this reference or discussion is not an admission that the document, act, or item of knowledge or any combination thereof was at the priority date, publicly available, known to the public, part of common general knowledge, or otherwise constitutes prior art under the applicable statutory provision; or is known to be relevant to an attempt to solve any problem with which this specification is concerned.

### SUMMARY

A preferred embodiment of the present invention is directed to a multiple-pod brewing apparatus. Embodiments of the apparatus may be accomplished as a complete brewing machine comprising a pump, heating element, basket, pod holder, water reservoir, and housing. Other embodiments of the present invention may be realized as comprising only those components that hold the one or more pods and distribute the heated water through the pod or pods.

The present invention may address one or more of the problems and deficiencies of the prior art discussed above. However, it is contemplated that the invention may prove useful in addressing other problems and deficiencies in a number of technical areas.

Therefore, the claimed invention should not necessarily be construed as limited to addressing any of the particular problems or deficiencies discussed herein.

### BRIEF DESCRIPTION OF THE DRAWINGS

These and other features, aspects, and advantages of the present invention will become better understood with regard to the following description, appended claims, and accompanying drawings where:

FIG. 1 is a partial view of an appliance with an embodiment of the present invention installed; and

FIG. 2 is a composite view showing a cross-sectional detail view of an embodiment of the present invention.

### DESCRIPTION

In the Summary above, in the Description below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, structures, steps, etc. are optionally present. For example, an article “comprising” (or “which comprises”) components A, B, and C can consist of (i.e., contain only) components A, B, and C, or can contain not only components A, B, and C, but also one or more other components or structures.

The term “at least” followed by a number is used herein to denote the start of a range beginning with that number (which may be a range having an upper limit or no upper limit, depending on the variable being defined). For example, “at least 1” means 1 more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40% means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

Before describing in detail embodiments that are in accordance with the present invention, it should be observed that some of the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

While the specification will conclude with claims defining the features of embodiments of the invention that are regarded as novel, it is believed that the invention will be better understood from a consideration of the following description in conjunction with the figures, in which like reference numerals are carried forward.

The disclosure herein, including the figures, discuss an innovative apparatus for brewing multiple beverage pods simultaneously. Typically, coffee makers have a water reservoir, a heating element, and components for delivering the heated water to a brew basket where it is poured over the coffee grounds and allowed to steep before dripping into a carafe or other beverage container. The invention is contemplated to be incorporated into a coffee maker, therefore, other elements of the coffee maker, as may be already known in the art, are not disclosed or discussed for the sake of simplicity.

Where general coffee maker structure is shown in the figures, said structure is shown for environmental reference and do not form part of the claimed invention, unless specifically described as such.

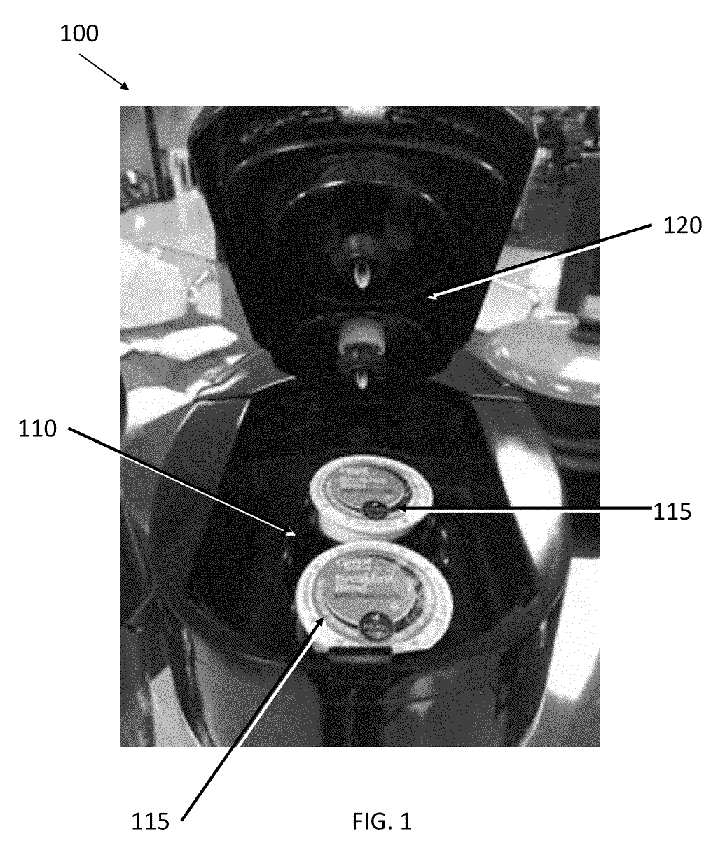

Referring to the figures in general, and to FIG. 1 in particular, we describe a multiple-pod brewing apparatus 100. The multiple-pod brewing apparatus 100 disclosed in FIG. 1 is shown as installed in a coffee maker appliance adapted for use with the multiple-pod brewing apparatus 100. A preferred embodiment of the apparatus comprises: a pod basket 110 having a two or more pod receptacle, wherein each of the two or more pod receptacle is configured to receive a pod 115; and a manifold 120, where the manifold 120 is configured to receive a water flow and distribute said water flow only to the pod receptacles that are populated with pods.

### The Pod Basket 110

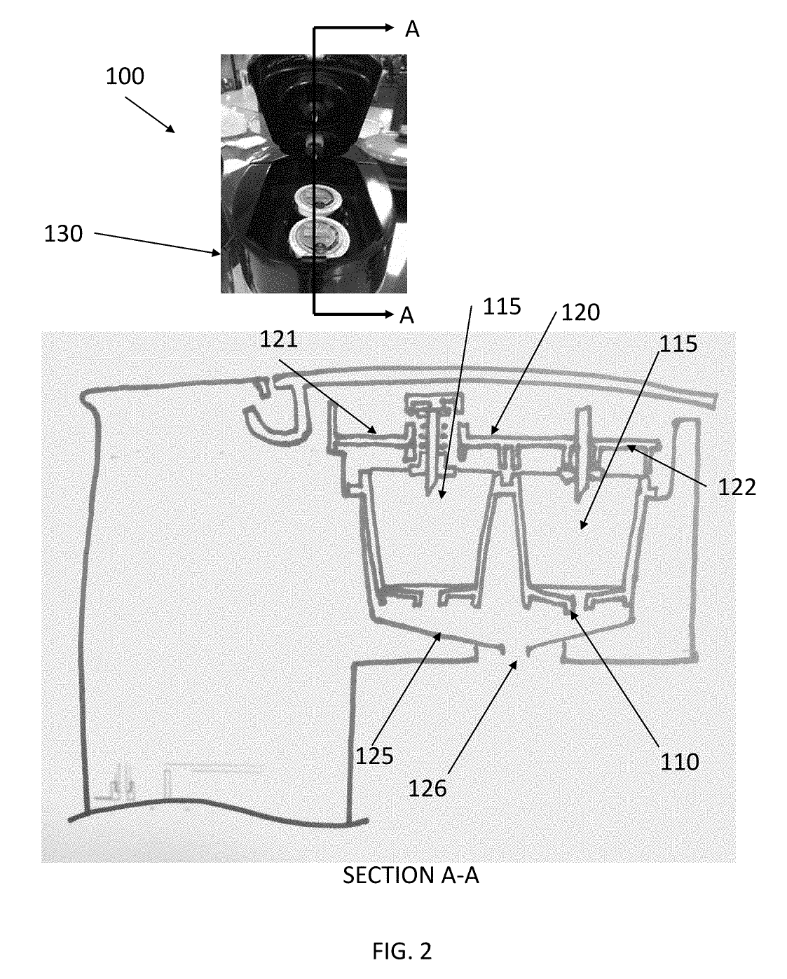

The pod basket 110 is a component of the multiple-pod brewing apparatus 100 that is comprised of two or more receptacles configured to receive one or more standard pods 115. See FIGS. 1 and 2.

As discussed above, standard pods are known in the art and are provided by multiple suppliers and manufacturers. It is contemplated to be within the scope of the present invention that different versions of the pod basket 110 may be designed to accommodate pods from different manufacturers, or even new pod styles that have not yet been developed as of the time of this disclosure. The general description of a “standard pod” is understood to mean a substantially sealed container with an organic material integral thereto, whereby the container may be pierced to introduce water into the interior and therein co-mingle with the organic material, steep, and dispense the steeped liquid.

Each receptacle is separate from the next so that the interior of each receptacle is not accessible by any other receptacle. In other words, water flowing into one receptacle is blocked from entering any other receptacle. The base of each receptacle is configured with a drain.

Other embodiments of the pod basket 110 also comprise a secondary receptacle 125 configured to catch the output from each pod receptacle drain 111, flow to a common point, and dispense out through one common output drain 126. This common output drain may be further configured to dispense only when a mug or other container are present to receive the brewed beverage. It is known in the art to accomplish this through a spring loaded stopper or similar mechanism.

It is further contemplated to be within the scope of the present invention that different types of beverages may be loaded into each pod receptacle. For example, a pod for espresso may be loaded into one pod receptacle and a pod for milk may be loaded into another pod receptacle. In this way, the multiple-pod brewing apparatus 100 enables a user to prepare a café-au-lait in one step instead of first having to prepare the espresso and then the milk as is currently known in the art.

In the case of pods requiring the creation of an outlet hole, embodiments of the invention further contemplate pod basket further comprising a cannula, or similar structure, configured to pierce the pod so that the steeped liquid may exit the pod and flow through the pod receptacle drain 111.

### The Manifold 120

The manifold 120 is a component of the multiple-pod brewing apparatus 100 that is comprised of a water barrier portion and a two or more water dispensing mechanisms configured to direct a water flow from a water dispensing means, such as a pump or percolator, to only those receptacles of the pod basket 110 that are populated with a pod 115. See FIGS. 1 and 2, and specifically, Section A-A of FIG. 2. Embodiments of the water barrier portion are configured with a water-side 121 and a pod-side 122. On the water-side, the water barrier portion is configured to direct the water flow to the two or more water dispensing mechanisms while constraining the water flow from migrating to other parts of the apparatus. On the pod-side, embodiments of the water barrier portion are configured with one or more protrusions to seal off on each pod. This seal need-not be watertight. The protrusions are also configured to hold each installed pod in its pod receptacle.

Embodiments of the two or more water dispensing mechanisms are configured such that each manifold 120 has one water dispensing mechanism for each receptacle of the pod basket 110. At least two embodiments of the water dispensing mechanism are contemplated to be within the scope of the present disclosure. One embodiment of the water dispensing mechanism is comprised of a needle with an inlet and an outlet, and a sealing means at the needle outlet. The needle traverses the water barrier portion and is adapted so that the needle inlet is open to the water-side of the water barrier portion and the needle outlet is adapted to open to the pod-side of the water barrier portion. The needle outlet is further adapted to pierce the pod installed in the corresponding pod receptacle. The sealing means at the needle outlet is a silicon, rubber, or other compliant material that is adapted to conform to the top of the pod and provide a seal around the needle outlet/pod interface.

A second embodiment of the water dispensing mechanism is as described above, but further comprises a spring loaded valve mechanism. The spring loaded valve mechanism is configured so that water is allowed to flow through the needle (valve open) only when a pod is present in the corresponding pod receptacle. In a use case where a pod receptacle is empty (no pod present), the spring loaded valve mechanism is not actuated (valve closed) thereby preventing the flow of water through the needle into that corresponding pod receptacle.

It is contemplated to be within the scope of the present invention that the manifold 120 may comprise water dispensing mechanisms that include only spring loaded valve mechanisms, no spring loaded valve mechanisms, or a combination of water dispensing mechanisms with and without spring loaded valve mechanisms.

Another embodiment of the present invention discloses a multiple-pod brewing system 200 comprised of a multiple-pod brewing apparatus 100 and a coffee maker apparatus 210. In this embodiment, the multiple-pod brewing apparatus 100 is a component as disclosed above. The coffee maker apparatus 210 is a component comprised of standard coffee maker components, as is known in the art, but further adapted to mechanically and functionally receive the multiple-pod brewing apparatus 100.

Further embodiments of the present invention disclose a multiple-pod brewing system as described above, where the system is further adapted to brew regular coffee, without the multiple pod apparatus. In this embodiment, it is contemplated that the multiple pod apparatus component may be removed and a traditional coffee basket is left for use with filters or other means known in the art.

Yet another embodiment of the present invention contemplates a kit apparatus comprised of a pod basket 110 and a manifold 120, as described and disclosed herein, that are configured to replace or modify the coffee basket of a standard drip coffee maker. In this way, the kit apparatus, when installed in a standard drip coffee maker, enable a user to brew beverages using standard pods instead of loose grounds and filters.

It is understood that the variations and options disclosed above with respect to the components of the apparatus embodiments, are also applicable as variations and options with respect to the components for the system embodiments.

In light of the foregoing description, it should be recognized that embodiments in accordance with the present invention can be realized in numerous configurations contemplated to be within the scope and spirit of the claims. Additionally, the description above is intended by way of example only and is not intended to limit the present invention in any way, except as set forth in the claims.

1. A multiple-pod brewing apparatus, the apparatus comprising:
a pod basket having a two or more pod receptacle, wherein each of the two or more pod receptacle is configured to receive a pod; and
a manifold, wherein said manifold is configured to receive a water flow and distribute said water flow only to the pod receptacles that are populated with pods.
